(19) United States
(12) Patent Application Publication
(10) Pub. No.: US 2001/0035256 A1
(43) Pub. Date: Nov. 1, 2001

(54) Vehicle glass coating

(75) Inventors: Richard Hall, Nunawading Victoria (AU); Robert Kim Thorburn, Glen Waverly Victoria (AU)

Correspondence Address: OLDHAM & OLDHAM CO, TWIN OAKS ESTATE, 1225 W MARKET STREET, AKRON, OH, 44313, US

(73) Assignee: Sun-Gard Australia Pty Ltd.

(21) Appl. No.: 09/792,655

(22) Filed: Feb. 23, 2001

(30) Foreign Application Priority Data
Feb. 24, 2000 (AU) PQ5839

(51) Int. Cl. B32B 31/10; B60J 3/00; B29C 31/00

(52) U.S. Cl. 156/212; 156/84; 156/108; 156/229; 156/250

(57) ABSTRACT

The present invention provides a method of shaping a sheet of polymeric film to substantially conform to a curved surface of a rigid substrate, such as a vehicle windscreen. The method includes the steps of:

cutting the sheet of polymeric film to a size appropriate to the rigid substrate;

positioning the sheet adjacent the substrate; and

applying heat to the sheet of polymeric film using an infrared or radiative heat source such that said heat is substantially uniformly distributed over a portion of the sheet comprising an area of at least about 500 cm² at any given time to shrink and/or stretch the sheet of film thereby causing the sheet to conform to the curvatures of the substrate. This step of applying heat is therefore typically performed In the absence of any forced air-flow.

The invention furthermore provides a method of coating a curved surface of a rigid substrate, such as a vehicle windscreen with a sheet of polymeric film, including the steps of:

shaping the sheet of polymeric film to substantially conform to the curved surface of the substrate as described above; and

adhesively bonding the shaped sheet of polymeric film to the curved surface of the rigid substrate.

### FIELD OF THE INVENTION

The present invention relates to glass coating and, more particularly, to a method of shaping sheets of polymeric coating film material suitable for forming a tinted or otherwise protective surface on a rigid substrate such as vehicle glass.

### BACKGROUND OF THE INVENTION

Colorized or tinted glass is used in a vast variety of modern applications in order to provide a measure of sun protection. In many applications, ranging from sunglasses to planar window glass in commercial environments, the glass contains a component such as a pigmentation added during manufacture, which serves to limit the energy transmission properties of the glass, In other applications, the tinting is provided by way of an additional layer of tinted material applied to the surface of the glass after manufacture, to provide a glass/plastic laminate. For example, in the case of vehicle glass such as a side window, rear window or sunroof, glass tinting may be provided as an optional feature on a basic vehicle specification, and the tinting is then applied as a post-manufacture modification at some stage in the distribution chain.

The tinting layer may be provided in one of two ways. Firstly, a tinted composition such as a metallic material or a tinted polymer can be applied to the glass surface as a coating by spraying or similar, and then cured by way of an appropriate technique. Secondly, a piece of preformed polymeric tinting film may be cut to size and applied and bonded to the glass surface by way of an appropriate adhesive, provided for example as a self-adhesive layer, the adhesive initially covered in a removable release film. This latter method is preferred in application to vehicle window glass because it affords a very straightforward and reliable method of providing an extremely uniform tinted coating to the glass.

One problem associated with the application of such film to the rear or side windows of vehicles is that the glass is often an integral part of modem vehicle styling and therefore often formed with curvatures in orthogonal directions, in order to match the shaping of the surrounding bodyworks of the vehicle without any discontinuity of form. The planar polymeric film material must therefore be both cut to size and shaped to match the curved form of the glass.

Conventionally, this problem has been addressed by first cutting a sheet of polymeric film material to size, applying the cut sheet to the (outer) convex surface of the window glass to which it temporarily adheres due to hydrostatic, electrostatic or surface tension effects, and then applying localised convectional heat by way of a hot air gun to the portions of the sheet that, due to the curvature of the vehicle glass, are not congruent with the glass surface. The hot air in the areas to which it is applied causes the polymeric film to rapidly shrink in those areas and therefore approximately conform to the local curved surface of the glass. The hot air gun, also known as a “heat gun”, of the variety commonly used for a paint-stripping or plastic welding, has been used in this process because it very effectively localises the heat provided, allowing the operator to direct it only to the areas of film which need to be shrunk.

Traditionaily a wet shrinking technique was used for this process, whereby the window surface was first wetted and the cut sheet pushed down onto the surface by the operator to adhere by hydrostatic force over the majority of the sheet surface area, leaving only a number of localised elongate ‘tunnel-form’ non-contact edge portions which could then be individually targeted by the heat gun operator. More recently, a dry shrinking process has been employed, whereby the glass surface is cleaned/polished and left dry, and the cut sheet adhered by electrostatic or similar forces to the surface in only its approximately central portion. This leaves considerably larger ‘floating’ non-contact areas to be subsequently heat treated, but the result is a generally improved shape, when compared with the result of the wet shrinking technique. However, the process is labour intensive, as the operator is required to carefully play the heat gun over the larger non-contact areas to shrink them as evenly as possible.

This film shaping is carried out with the adhesive surface and release layer uppermost, and once the polymeric film has been shaped in the manner described above it is removed from the outer convex surface of the glass, the removable release coating layer removed, and the exposed adhesive side of the film applied to the inner surface of the glass. This is generally done by first wetting the glass to allow the operator to use a squeegee or similar to readily urge the film onto the glass surface by “squeegeeing” out air and water trapped between the two applied surfaces, Modem polymeric films are, to a greater or lesser extent depending on the constituents, vapour permeable, and the final step of the process merely involves allowing the applied coating to dry, any moisture still present evaporating through the permeable polymeric film over a period of time depending on the temperature, humidity and the film construction and thickness.

The conventional process described above is generally very effective as it can be applied to all different shapes and areas of vehicle glass. However, it does tend to be considerably labour Intensive and operator-dependent, particularly when the preferred dry shrinking technique is employed, as the heat gun is difficult to control accurately and the gun operator needs therefore to apply it extremely carefully to the appropriate areas of polymeric film, to ensure the areas are sufficiently heated (but not overheated or melted) to provide the desired shrinkage, without affecting the surrounding areas. As a rough guideline, the rear window of a modern SUV or estate car can require around 60 minutes of skilled operator time to shape and apply a tinted polymeric coating.

An additional problem can arise with the conventional technique described above. The heat gun produces a localised flow of air over an area of a few square centimeters at an extremely elevated temperature which can rise to around 650° C. This intense localised heat leads to an effective shrinkage of the polymeric film, but has been found also to tend to overheat or even melt polyester film (which has a melting point of around 250° C.) and to lead to a marked localised breakdown in the polymeric film adhesive, as well as to areas of potential weakness or localised stresses between unheated and heated portions of the film. This may not be evident when the film is first applied, but can lead to subsequent loss of adherence and color change or fogging of the film after a period of use, especially if used in warm climatic conditions. Overheated areas of film can fail to adhere to the glass in localised areas, such as areas where it passes over irregularities in the surface such as heater demister bars, and this can make the finishing of the film application very difficult.

In view of the above, it would be clearly desirable to provide an improved method of coating vehicle glass which at least partially addresses the problems and inconveniences of the prior art.

### SUMMARY OF THE INVENTION

According to one aspect, the present invention provides a method of shaping a sheet of polymeric film to substantially conform to a curved surface of a rigid substrate, such as a vehicle windscreen, including the steps of:

cutting the sheet of polymeric film to a size appropriate to the rigid substrate;

positioning the sheet adjacent the substrate; and

applying substantially uniformly distributed heat to at least a portion of the film with an infrared or radiative heat source to shrink and/or stretch the sheet of film thereby causing the sheet to conform to the curvatures of the substrate. Preferably, the portion of the film to which said substantially uniformly distributed heat is applied comprises an area of at least about 500 cm² at any given time.

According to another aspect, the present invention provides a method of shaping a sheet of polymeric film to substantially conform to a curved surface of a rigid substrate, such as a vehicle windscreen, including the steps of:

cutting the sheet of polymeric film to a size appropriate to the rigid substrate;

positioning the sheet adjacent the substrate; and

applying heat to the sheet of polymeric film such that said heat is substantially uniformly distributed over a portion of the sheet comprising an area of at least about 500 cm² at any given time to shrink and/or stretch the sheet of film thereby causing the sheet to conform to the curvatures of the substrate,

Preferably, the step of applying heat is performed using an infrared or radiative heat source, and preferably in the absence of any forced airflow.

In a preferred form of the invention, the above method further includes the step of physically assisting the sheet of polymeric film to conform to the curvatures of the substrate by smoothing over any non-congruent heated portions of the polymer film sheet by hand, or alternatively, with a flexible brush or spatula device. In many cases, however, the film sheet will not require such assistance.

In a preferred form of the invention, the step of positioning the sheet adjacent the substrate Includes laying the sheet on or against an outer surface of the substrate.

According to a further aspect, the present invention provides a method of coating a curved surface of a rigid substrate, such as a vehicle windscreen, with a sheet of polymeric film, including the steps of:

shaping the sheet of polymeric film to substantially conform to the curved surface of the substrate according to the method described above, and

adhesively bonding the shaped sheet of polymeric film to the curved surface of the rigid substrate.

The invention thus provides a method of shaping a sheet of polymeric film material to substantially conform to the curved surface of a rigid substrate, the method including the steps of providing a sheet of polymeric film material cut to a size and shape appropriate to said rigid substrate, and applying heat from an infrared or radiative heat source to at least a portion of said sheet to cause differential shrinkage or stretching of the polymeric film material thereby to conform said sheet to the curved surface of said rigid substrate whilst minimising the risk of damage to said polymeric film material.

The invention, then, affords a process of shaping a sheet of polymeric film material to substantially conform to the curved surface of a rigid substrate by applying heat to at least a portion of said sheet to cause differential stretching of the polymeric film material, in the absence of a forced air flow, thereby to conform said sheet to the curved surface of said rigid substrate.

In complete contrast to conventional practice, the invention contemplates applying the required heat to the polymeric film material from an infrared or radiative heat source. Contrary to the general understanding in the industry, the inventor of the present invention has found that such a heat source may be applied to an area extending beyond the boundaries of the localised film portions to be shrunk without damaging or otherwise affecting the film. The infrared or radiative heat source is able to provide less aggressive heating to the film and to avoid the hotspots associated with heat guns which is now understood to lead to the undesirable breakdown of the polymeric film adhesive referred to above. Furthermore, the heat is able to be delivered or applied much more uniformly compared with the conventional techniques. The improved heat distribution results from the application of heat over a considerably larger area than hitherto possible, and this means that a larger area of the film can be treated in one go with far less dependence on operator ability, the film more accurately self-molding to the surface shaping than hitherto possible. As a general indication of the improvement provided, it has been determined in tests that all the windows of a modem SUV or estate car can be coated with tinted film by a skilled operator in approximately 60 minutes, providing a significant time saving when compared with the time required by the same operator using the conventional approach.

The polymeric film material is preferably a polyester material, the particular material selected depending on the specific application of interest. Typically such films have a thickness of between about 25 and 100 μm, but they can be as thick as 350 μm or even 550 μm.

The polymeric film material is preferably tinted to restrict transmission therethrough of selected electromagnetic radiation, the tinting being provided by means of, for example, dyes, pigments, metals, metal alloys or ceramics, which may be added to the polymeric film material, or preferably deposited or sandwiched within said sheet of polymeric film material. For example, vapour-deposited or sputter-coated aluminium coatings are commonly used in vehicle tinting products.

In a preferred form, the polymeric film material is provided with an adhesive coating, preferably a self-adhesive layer of a cross-linked acrylic adhesive covered in a removable protective release film.

The rigid substrate is preferably a glass window, but may of course be made from transparent plastics material, or from other materials, transparent or otherwise.

Preferably, in the case of a glass or plastic window, the sheet of polymeric film material is first applied to a convex surface of said window and shaped thereto, then removed, applied and bonded to the reverse (concave) surface of the window.

The infrared or radiative heat source preferably comprises one or more infrared elements provided in a panel-like array, providing a roughly uniform temperature over a selected area. A number of such heat source units may be used simultaneously, arranged to approximately conform to said curved surface. An infrared heat source that has been found suitable is a panel unit conventionally used for curing of oven-baked enamel paint. Such a unit may be power rated at about 1KW and provide a roughly uniform heating over an area of about 0.25 m² (ie 2,500 cm²).

The temperature reached within the polymeric film due to the application of the infrared or radiative heat source is likely to be significantly lower than that achieved with a heat gun, but is of course applied over a considerably larger area. The resulting shrinkage of the film is therefore more gradual, but because a larger area of the film can be treated at any given time, the overall result is a faster process. Because of the significantly more gentle application of heat according to the present invention, the film is far less likely to suffer any damage during shaping of the film sheet. Importantly, the film tends not to become overheated using the method of the invention because as the film shrinks and flattens against the vehicle glass, the glass then acts as a heat sink conducting heat away from the film, thus avoiding the afore-mentioned problems of film degradation associated with excessive temperatures.

Preferably, the method includes the step of first applying said sheet of polymeric film material to said surface to define at least one portion in which the film is congruent with said surface and one or more non-contact portions, which require heat shrinkage to enable them to conform with said surface, and then applying the infrared or radiative heat source to an area extending beyond the boundaries of one or more of said non-contact portions. The heat source preferably extends over a surface area at least 500 cm², providing a substantially uniform heat distribution over a similar area.

It is to be noted that, in the case of certain plastic film compositions, the application of heat may also be used to locally stretch the polymeric film material, rather than to shrink it, and this effect may equally be used in a method according to the invention to conform said sheet to said surface.

### BRIEF DESCRIPTION OF THE DRAWINGS

Further details and advantages of the present invention will become more readily apparent from consideration of the following description of a preferred embodiment with reference to the accompanying drawing figures, in which:

FIG. 1 depicts a sheet of tinted polymeric film material for use in application to vehicle glass; and

FIG. 2 illustrates the method of the invention as applied to the rear window of a vehicle.

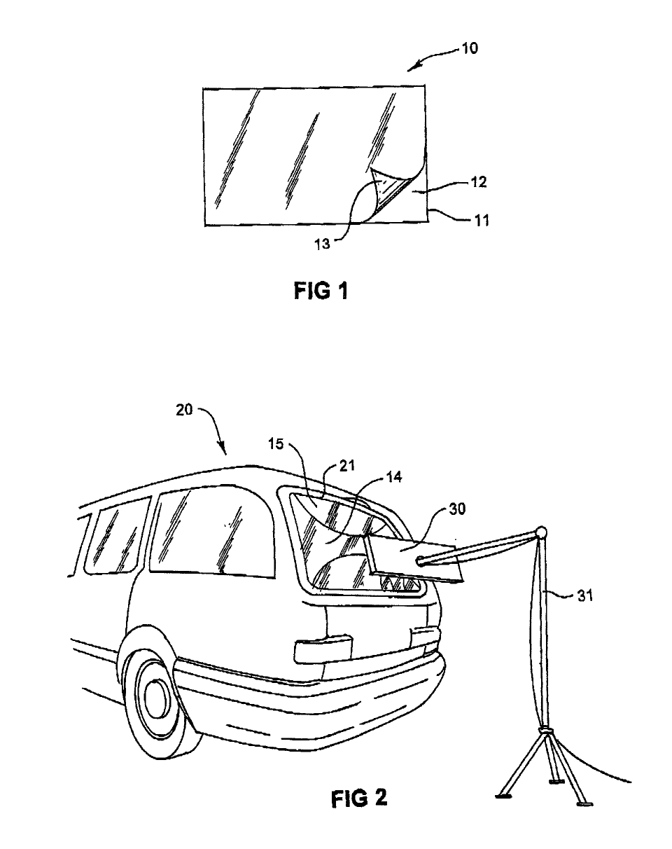

### DETAILED DESCRIPTION OF THE PREFERRED EMBODIMENT

The polymeric film sheet 10 consists of a generally rectangular sheet of tinted polyester film material of approximate thickness between 25 and 50 μm, which carries on one side a layer of polymeric adhesive 12, covered with a thin removable release layer 13. A suitable sheet material is available under the name of SunGard Perform X™, Endurance™ or Desert Smoke™.

The rear window 21 of a vehicle 20 has a convex outer surface and curvatures in orthogonal directions, and this naturally presents problems of conformity with a planar film. In applying tinted or otherwise protective coating to such a surface, the operator first offers up sheet 10 to the cleaned outer surface of rear window 21, usually with the covered self-adhesive side of the sheet facing outwardly, and uses a suitable tool to carefully cut the sheet to an appropriate size for the window. The sheet remains in position due to electrostatic or other surface effects and the operator ensures that at least the generally central portion 14 lies congruent with the outer surface of the rear window glass, then smoothing at least part of the peripheral portion of sheet 10 (usually the lateral areas) into contact with the glass surface. Because of the compound curvature of the glass, sheet 10 will not contact the glass in the remaining edge portions, generally indicated at 15, where the planar film does not conform with the glass shaping and is thus free to float above the glass surface.

Once the operator has arranged sheet 10 such that the non-contact portions 15 are approximately evenly distributed around the periphery of window 21, an infrared or radiative heat source 30, either hand-held or on a support stand 31 as shown in FIG. 2, is brought into a position approximately 45 cm from the film. Heat source 30 is constituted by one or more infrared heat panels and its radiation field covers an area of approximately 50 cm×50 cm. It is not a problem if the area heated encompasses one or more of the non-contact portions 15 as well as part of the contact portion 14, as it is found that the distribution of heat provided by this method serves to shrink the non-contact portions 15 while not adversely affecting the film in contact portion 14 in any way. It is understood that the window glass with which contact portion 14 is in contact serves to dissipate the absorbed radiative heat away from the film, whilst the non-contact portions 15 cannot dissipate the radiative heat they absorb in the same way, and are therefore subject to the heat treatment and the desired localised shrinkage. The process, then, tends to automatically serve to localise the heat treatment to the non-contact areas, avoiding to a large extent the operator dependence of the procedure. As the non-contact portions 15 begin to shrink, certain areas of those portions will begin to contact the glass surface, and the heat treatment will then be automatically localised in the remaining non-contact areas of those portions 15.

The application of the infrared or radiative heat to a relatively large area of film sheet 10 helps avoid the risk of weakened transition zones between heated and wholly unheated portions of the material, and significantly speeds up the whole process. Furthermore, in contrast with the conventional heat gun technique, there is no forced airflow against the polyester sheet to undesirably urge the non-contact portions against the surface before they have been uniformly shrunk.

The entire rear window of the vehicle may be heat treated in this way with only a small number of applications of heat source 30 to cover all the appropriate parts of sheet 10. Alternatively, a single larger heat source, preferably shaped to conform with the entire rear window form, may be used to heat treat the entire area of sheet 10 in just a single step.

Once the heat treatment is complete and sheet 10 is fully congruent with the window 21, the shaped film sheet 10 is removed from the outer surface of the glass and the protective release layer 13 removed to expose the adhesive layer 12, now on the convex curved surface of sheet 10. The operator applies water (or an alternative appropriate wetting agent) to the inner surface of the rear window glass and offers up the adhesive surface of shaped film sheet 10 to that inner surface. The wetted surface prevents the adhesive from immediately holding fast and so readily allows repositioning of sheet 10 once it has been brought into contact with the glass. When the operator is happy with the positioning of sheet 10, a squeegee blade is used, preferably in strokes radiating outwardly from the central area of the sheet, to force air and water out and so adhere sheet 10 in place against the glass. Finally, the coated window may be dried to remove any moisture still present between the surfaces, and this is preferably done by means of solar radiation, although a large-area infrared heat source positioned external to the window glass may also optionally be used. As mentioned earlier, the polymeric film material is vapour permeable, so the moisture is able to readily evaporate away through sheet 10, and the external heating allows the glass to conduct the drying heat to where it is needed.

The invention has been described with reference to the rear window of a vehicle, but it is clear that it is equally applicable to a very wide range of other applications involving the application of a polymer film to a shaped substrate. In the vehicle industry alone, a tinted or otherwise protective film may be applied using the technique of the invention to side windows, sunroofs, windscreens, sun visors and mirrors. In the construction field, the method may be used to apply tinting to glass or plastic domed skylights or other window areas. The skilled reader will readily appreciate the many other applications that such a process may have.

It will be understood that various modifications, alterations and/or additions may be made to the embodiments specifically described and illustrated herein without departing from the spirit and scope of the invention as set out in the appended claims.

We claim:

1. A method of coating a curved surface of a rigid substrate, such as a vehicle windscreen, with a sheet of polymeric film, including the steps of:
shaping the sheet of polymeric film to substantially conform to the curved surface of the substrate, including:
(i) cutting the sheet of polymeric film to a size appropriate to the rigid substrate;
(ii) positioning the sheet adjacent the substrate; and
(iii) applying substantially uniformly distributed heat to at least a portion of the film with an infrared or radiative heat source to shrink and/or stretch the sheet of film thereby causing the sheet to conform to the curvatures of the substrate; and
adhesively bonding the shaped sheet of polymeric film to the curved surface of the rigid substrate.

2. A method as claimed in claim 1, wherein the step of positioning the sheet adjacent the substrate includes laying the sheet on or against an outer surface of the substrate.

3. A method as claimed in claim 2, further including the step of:
removing the shaped sheet of polymeric film from said outer surface of the substrate; and
wherein the curved surface to which the shaped sheet is adhesively bonded is on a side of the substrate opposite said outer surface on or against which the sheet of polymeric film was shaped.

4. A method as claimed in claim 1, wherein said portion of the film to which said substantially uniformly distributed heat is applied comprises an area of at least about 600 cm² at any given time.

5. A method as claimed in claim 4, wherein said portion of the film comprises an area of about 2,500 cm².

6. A method as claimed in claim 1 further including the step of physically assisting the sheet of polymeric film to conform to the curvatures of the substrate by smoothing over any non-congruent heated portions of the polymer film sheet by hand and/or with a flexible brush or spatula device.

7. A method as claimed in claim 1 wherein the sheet of polymeric film is formed from a polyester and has a thickness in the range of 25 to 550 μm.

8. A method of coating a curved surface of a rigid substrate, such as a vehicle windscreen, with a sheet of polymeric film, including the steps of:
shaping the sheet of polymeric film to substantially conform to the curved surface of the substrate, including:
(i) cutting the sheet of polymeric film to a size appropriate to the rigid substrate;
(ii) positioning the sheet adjacent the substrate; and
(iii) applying heat to the sheet of polymeric film such that said heat is substantially uniformly distributed over a portion of the sheet comprising an area of at least about 500 cm² at any given time to shrink and/or stretch the sheet of film thereby causing the sheet to conform to the curvatures of the substrate; and
adhesively bonding the shaped sheet of polymeric film to the curved surface of the rigid substrate.

9. A method as claimed in claim 8 wherein the step of applying heat is performed in the absence of a forced air-flow.

10. A method as claimed in claim 8 wherein the step of applying heat is performed using an infrared or radiative heat source.

11. A method as claimed in claim 8 further including the step of physically assisting the sheet of polymeric film to conform to the curvatures of the substrate by smoothing over any non-congruent heated portions of the polymer film sheet with a flexible brush or spatula device.

12. A method as claimed in claim 8 wherein the sheet of polymeric film is formed from a polyester and has a thickness In the range of 25 to 550 μm.

13. A method of shaping a sheet of polymeric film to substantially conform to a curved surface of a rigid substrate, such as a vehicle windscreen, including the steps of:
(i) cutting the sheet of polymeric film to a size appropriate to the rigid substrate;
(ii) positioning the sheet adjacent the substrate; and
(iii) applying substantially uniformly distributed heat to at least a portion of the film with an infrared or radiative heat source to shrink and/or stretch the sheet of film thereby causing the sheet to conform to the curvatures of the substrate.

14. A method of shaping a sheet of polymeric film to substantially conform to a curved surface of a rigid substrate, such as a vehicle windscreen, including the steps of:
(i) cutting the sheet of polymeric film to a size appropriate to the rigid substrate;
(ii) positioning the sheet adjacent the substrate; and
(iii) applying heat to the sheet of polymeric film such that said heat is substantially uniformly distributed over a portion of the sheet comprising an area of at least about 500 cm² at any given time to shrink and/or stretch the sheet of film thereby causing the sheet to conform to the curvatures of the substrate.

15. A method as claimed in claim 8 wherein the step of applying heat is performed in the absence of any forced air-flow.

16. A method as claimed in claim 8 wherein the step of applying heat is performed using an infrared or radiative heat source.
